(19) United States
(12) Patent Application Publication
(10) Pub. No.: US 2004/0147354 A1
(43) Pub. Date: Jul. 29, 2004

(54) Super duty continuously variable transmission (SDCVT)

(76) Inventor: Brian Andrew Kilduff, Canoga Park, CA (US)

Correspondence Address: Brian Kilduff, 7523 Alabama Ave. #21, Canoga Park, CA, 91303, US

(21) Appl. No.: 10/351,867

(22) Filed: Jan. 28, 2003

(51) Int. Cl. B22F 3/08; F16H 47/08

(52) U.S. Cl. 475/91

(57) ABSTRACT

This is a super duty continuously variable transmission that uses an input differential assembly 3, underdrive/accelerator pump assembly 4, output differential/decelerator pump assembly 5, overdrive assembly 6, and a reverse, neutral, direct assembly. All assemblies are planetary gear sets in nature. The accelerator pump 4 and decelerator pump 5 control the rotation direction of the first four assemblies which changes the output shaft ratio infinitely over an upper and lower limit. The pumps are of the variable vane type and as one is pumping, the other acts like a turbine with the first pumps high pressure fluid pushing the back of the second pumps vanes, and visa versa.

### CROSS REFERENCE TO RELATED APPLICATIONS

| July, 1990 | no name | Re.33,278 |
|---|---|---|
| December, 2002 | Schmidt | 6,491,599 |
| June, 1947 | Duer | 2,422,343 |

### STATEMENT REGARDING FEDERALLY SPONSORED RESEARCH OF DEVLOPMENT

Not applicable

### REFERENCE TO SEQUENCE LISTING

Not applicable

### BACKGROUND OF THE INVENTION

Many attempts have been made with the continuously variable transmission (CVT) in the past. These designs are light duty in nature and do not address the need for a high torque capacity transmission. Light duty and heavy duty trucks are not compatible with the current (CVT) state of the art because of the high torque environment they must live in.

The (SDCVT) type transmission is desirable for its smooth operation and the illumination of shock on the drive train which extends service life. Clutch life is increased, with only engagement from a standing start being necessary. Also, the engine can be kept at a constant speed for which it is most efficient.

### BREIF SUMMARY OF THE INVENTION

The (SDCVT) addresses these needs by not using the V-belt type transmission that is currently popular. The (SDCVT) uses four planetary gear sets for the infinite gear ratios over a given high and low limit; One set as an input differential, one set as an output differential, one set as an overdrive gear increaser and one set as an underdrive gear reducer. A fifth planetary gear set is used only for revese, neutral and direct drive (RND). “Direct drive” in this application only means direct (1:1) across (RND) planetary gear set, not direct across the entire transmission.

Torque is allowed to pass either only through the overdrive gear (highest gear ratio) or only through the underdrive gear (lowest gear ratio), or an infinite combination there of.

Control is provided by two pumps which are of the variable vane type. These pumps provide resistance at either the input differential or the output differential to split the torque in the desired direction. Only a small amount of resistance force is required to manipulate the input torque because a differential has one input and two outputs so the torque always has some place to go.

The pumps also double as turbines, thereby recovering some of the lost energy caused during the pumping activity, therefore raising the overall efficiency of the transmission. As one of the pumps start working, the other acts as a turbine. This is similar to a torque converter that is reversible. Also, the pumps provide lubrication to the gears illuminating the need for the gears to spin through an oil bath as in manual transmissions, thereby increasing its efficiency.

The (SDCTV) uses a conventional clutch to initially engage the transmission. Reverse gear also benefits from the infinite gear range if desired.

A super duty continuously variable transmission with a input differential assembly 3, underdrive/accelerator pump assembly 4, output differential/decelerator pump assembly 5, overdrive assembly 6, and a reverse, neutral, direct assembly. The accelerator pump 4 and decelerator pump 5 control the rotation of the four planetary gears sets that determine the output shaft speed.

### BRIEF DISCRIPTION OF DRAWINGS

FIG. 1 is a sectional view of the case with the complete final gear assembly and shift linkage visible through the case.

FIG. 2 is a complete gear assembly with pick-up and transfer tubes.

FIG. 3 is an exploded view of FIG. 2.

FIG. 4 is an exploded side view of the input differential assembly.

FIG. 5 is a reverse view of FIG. 4

FIG. 6 is an exploded side view of the underdrive gear assembly and integrated accelerator pump assembly.

FIG. 7 is a reverse view of FIG. 6.

FIG. 8 is an exploded side view of the output differential assembly and integrated decelerator pump assembly.

FIG. 9 is a reverse view of FIG. 8.

FIG. 10 is an exploded side view of the overdrive gear assembly.

FIG. 11 is a reverse view of FIG. 10.

FIG. 12 is an exploded side view of the reverse, neutral, direct assembly (RND).

FIG. 13 is a reverse view of FIG. 12.

FIG. 14 is a side view of the counter shaft.

FIG. 15 is side view of the case with linkage.

FIG. 16 is a top view of FIG. 15.

FIG. 17 is a sectional side view of the inside case and linkage.

FIG. 18 is sectional view of the case with the final gear assembly showing all fixed points.

FIG. 19 is a schematic of the gear rotation in lowest underdrive.

FIG. 20 is a schematic of the gear rotation midway between lowest underdrive and highest overdrive.

FIG. 21 is a schematic of the gear rotation in highest overdrive.

FIG. 22 is a schematic of the (RND) in direct.

FIG. 23 is a schematic of the (RND) in reverse.

FIG. 24 is a schematic of the (RND) in neutral.

FIG. 25 is sectional side view of FIG. 2 without the (RND), transfer/pick-up tubes or non integrated pump parts.

FIG. 26 is a transparent view of the accelerator and decelerator pump activity from a standing start.

FIG. 27 is a transparent view of the accelerator and decelerator pump activity midway between underdrive and overdrive during acceleration.

FIG. 28 is a transparent view of the accelerator and decelerator pump activity in highest overdrive.

FIG. 29 is a transparent view of the accelerator and decelerator pump activity midway between overdrive and underdrive during deceleration.

FIG. 30 is a transparent view of the accelerator and decelerator pump activity coming to a dead stop.

A MASTER LIST OF ALL PARTS AND ASSEMLBIES

1—final gear assembly

2—(SDCVT) case

3—input differential assembly

4—underdrive gear assembly with integrated acceleration pump assembly

5—output differential with integrated deceleration pump assembly

6—overdrive gear assembly

7—reverse, neutral, direct gear assembly (RND)

8—transfer tube

9—transfer tube

10—pick-up tube

11—counter shaft

12—pick-up tube

13—input shaft

14—input base plate

15—input differential internal gear

16—input differential planet gear

17—input differential carrier

18—input differential sun gear and underdrive sun gear

19—accelerator pump cover

20—accelerator pump slide

21—accelerator pump vane

22—accelerator pump ring

23—underdrive carrier and integrated accelerator pump base

24—underdrive planet gear

25—underdrive internal gear

26—underdrive base plate with integrated output differential sun gear

27—output differential carrier

28—output differential planet gear

29—output differential internal gear with integrated decelerator pump base and overdrive

30—sun gear

30—decelerator pump ring

31—decelerator pump vane

32—decelerator pump slide

33—decelerator pump cover

34—overdrive carrier

35—overdrive planet gear

36—overdrive internal gear

37—(RND) sun gear

38—(RND) carrier

39—(RND) planet gear

40—(RND) internal gear and integrated output shaft

41—(RND) slider

43—accelerator pump shift cam

44—decelerator pump shift cam

45—accelerator pump shift lever

46—decelerator pump shift lever

47—(RND) shift lever

48—(RND) shift fork

49—decelerator pump shift rod

50—accelerator pump shift rod

### DETAILED DESCRIPTION OF THE INVENTION

Note: (A “MASTER LIST OF ALL PARTS AND ASSEMBLIES” has been created for easier identification.)

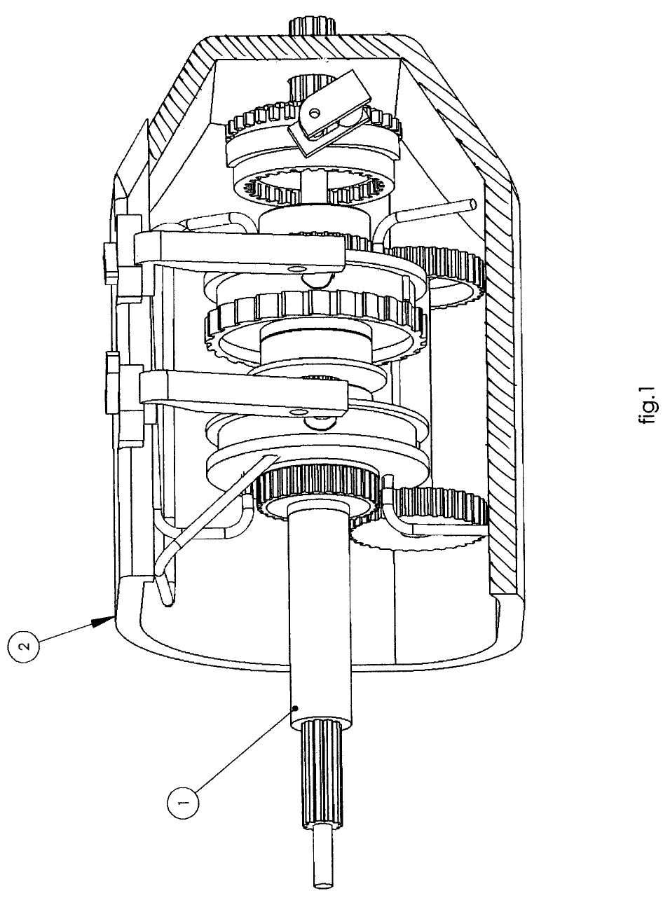

The (SDCVT) in this embodiment, is a longitudinal type transmission for use in vehicles with a rear axle. FIG. 1 shows a sectional view of the (SDCVT) case 2 with the final gear assembly 1.

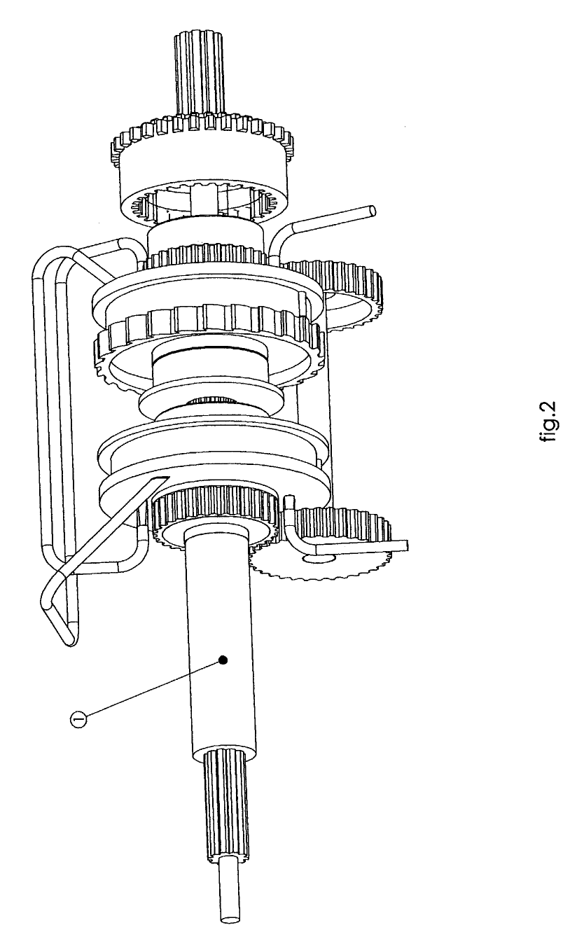

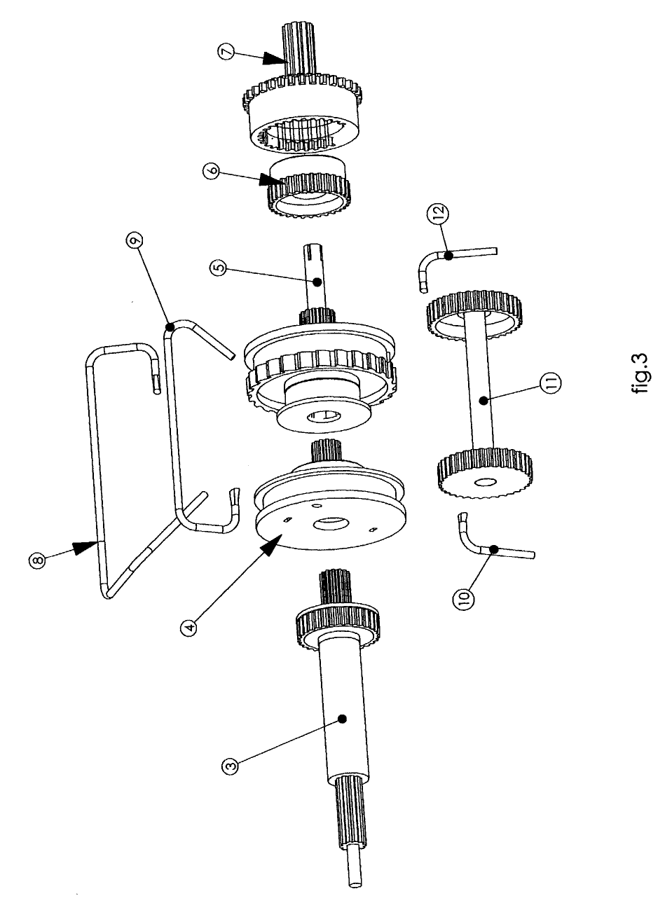

The (SDCVT) uses four planetary gear sets with different members being held to achieve the desired torque multiplication. An accelerator pump 4 and a decelerator pump 5 provide the control. The four planetary gear sets are as follows in FIG. 2;

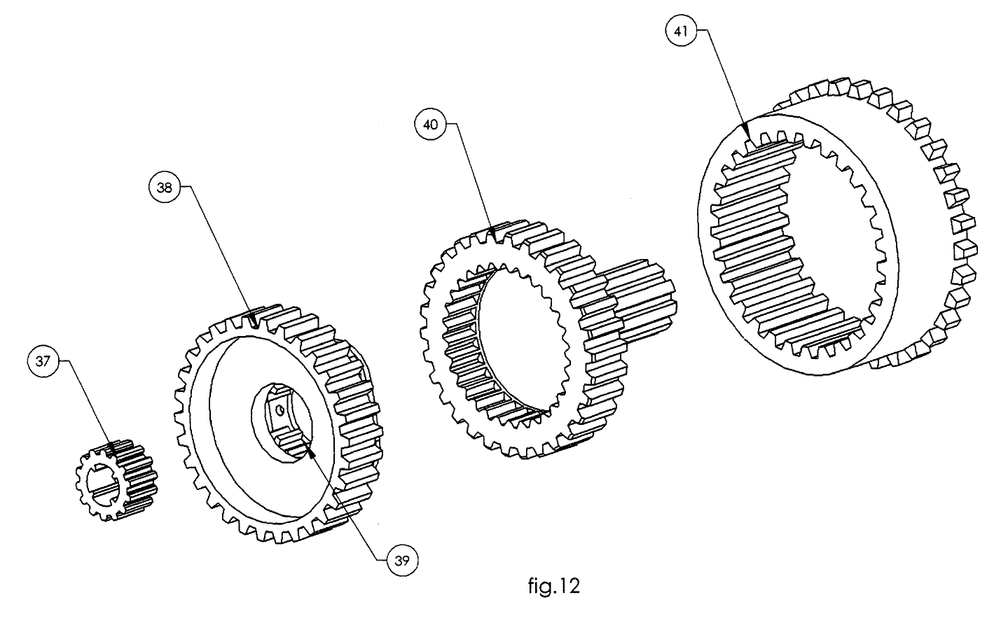

The input differential assembly 3, the underdrive gear/accelerator pump assembly 4, the output differential/decelerator pump assembly 5, and the overdrive assembly 6. A fifth planetary gear set, the reverse, neutral, direct (RND) assembly 7 FIG. 12, is used only for reverse, neutral and direct and is not effected by the pumps. The “direct” reference in the (RND) assembly only indicates direct (1:1) across the (RND) its self, not across the entire (SDCVT). A counter shaft 11 is necessary to deliver power between the overdrive assembly 6 and the input differential assembly 3. Transfer tubes 8 and 9 are used to direct oil between the pumps. Pick-up tubes 10 and 12 are used to feed the pumps from an oil bath.

For the sake of this application, all internal gears have 62 teeth, all planet gears have 17 teeth and all sun gears have 28 teeth. It is not necessary to have a planetary gear set with this exact tooth count or is it necessary to have each of the five planetary gear sets be exactly the same but for the sake clarity, it is easier to quantify this embodiment.

The following equations will help in verifying the gear ratios of this invention;

NI=# of teeth on the internal gear=62

NS=# of teeth on the sun gear=28

NP=# of teeth on the planet gear=17

If the internal gear is held and the sun gear drives the planet gear, therefore;

ratio=1+(NI/NS)=1+(62/28)=3.21:1

If the internal gear is held and the planet gear carrier drives the sun gear, therefore;

ratio=1/1+(NI/NS)=1/1+(62/28)=0.31:1

If the planet gear carrier is held and the sun gear drives the internal gear, then the gear set will go into reverse, therefore; ratio=(NINS)=(62/28)=2.21:1(reverse direction)

If the sun gear is held and the planet gear carrier drives the internal gear, therefore;

ratio=1+(NS/NI)=1+(28/62)=1.45:1

If the sun gear is held and the internal gear drives the planet gear, therefore;

ratio=1/1+(NI/NS)=1/1+(62/28)=0.68:1

In a planetary gear set, the planet gear can only be driven and the planet carrier can only drive, because of the link between the planet gear and the carrier.

For this discussion assume the input shaft is always turning clockwise at a constant speed.

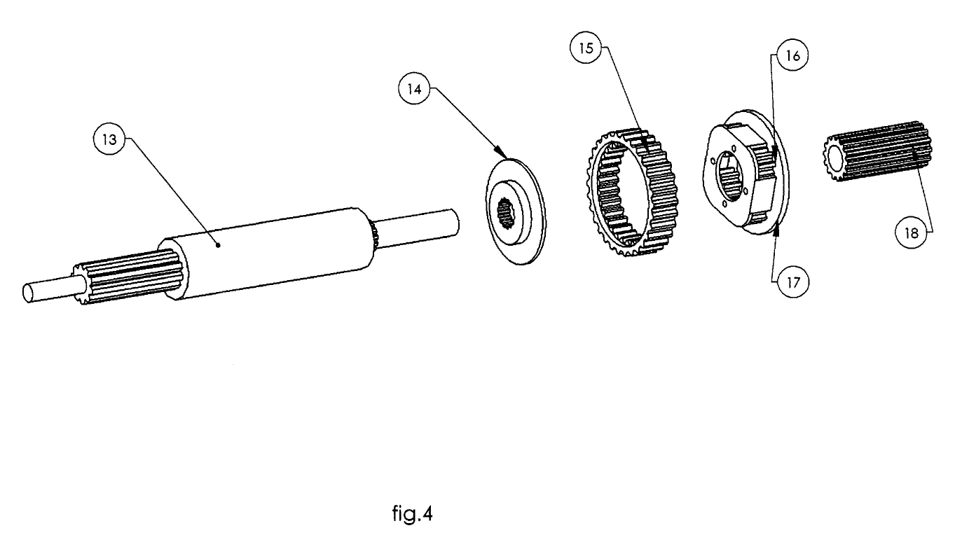

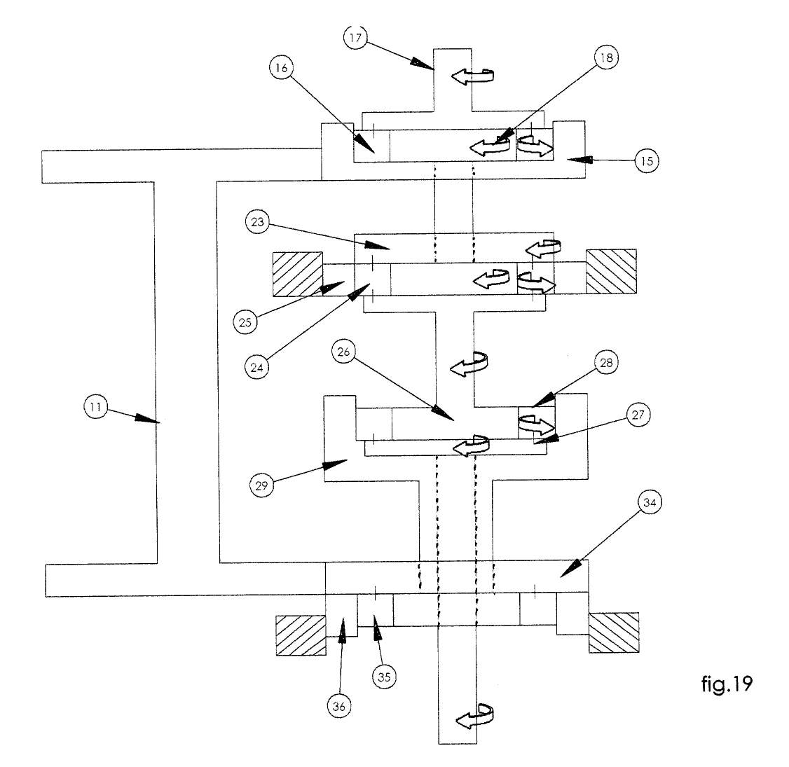

The scenario in FIG. 19 is acceleration from a standing start and the engine is driving the rear wheels (as opposed to the rear wheels driving the engine in deceleration). The output differential internal gear with integrated decelerator pump base and overdrive sun gear 29 FIG. 8 is prevented from turning counter clockwise by a dog (not shown) that would lock into the “shark fins” that extend from the outermost circumference. Since the output differential internal gear with integrated decelerator pump base and overdrive sun gear 29 is locked, it causes the input differential internal gear 15, the overdrive carrier 34, the overdrive planet gear 35 and the counter shaft 11 to lock. The engine is driving the input shaft 13 FIG. 4 which is splined to the input base plate 14 FIG. 4 which has dowels that insert the holes in the input differential carrier 17. The input differential carrier 17 drives the input differential and underdrive sun gear 18 through the input differential planet gear 16 because the input differential internal gear 15 is being held resulting in a 0.31:1 ratio. This continues with the input differential and underdrive sun gear 18 driving the underdrive base plate and integrated output differential sun gear 26 through the underdrive planet gear 24 where the underdrive internal gear 25 is always fixed (see FIG. 18) resulting in a 3.21:1 ratio. This continues with the underdrive base plate and integrated output differential sun gear 26 driving the output differential carrier 27 through the output differential planet gear 28 because output differential internal gear with the integrated decelerator pump base and overdrive sun gear 29 is being held resulting in a 3.21:1 ratio. Therefore the final ratio is 0.31×3.21×0.3.21=3.21 or 3.21:1.

The activity of the control pumps during this event is shown in FIG. 26. The output differential internal gear with integrated decelerator pump base and overdrive sun gear 29 is locked so the pump vanes 21 do not turn, but the underdrive carrier and integrated accelerator pump base 23 does turn. The underdrive carrier and integrated accelerator pump base 23 is turning but not pumping because the accelerator pump slide 20 is in a neutral, concentric position relative to the underdrive carrier and integrated accelerator pump base 23.

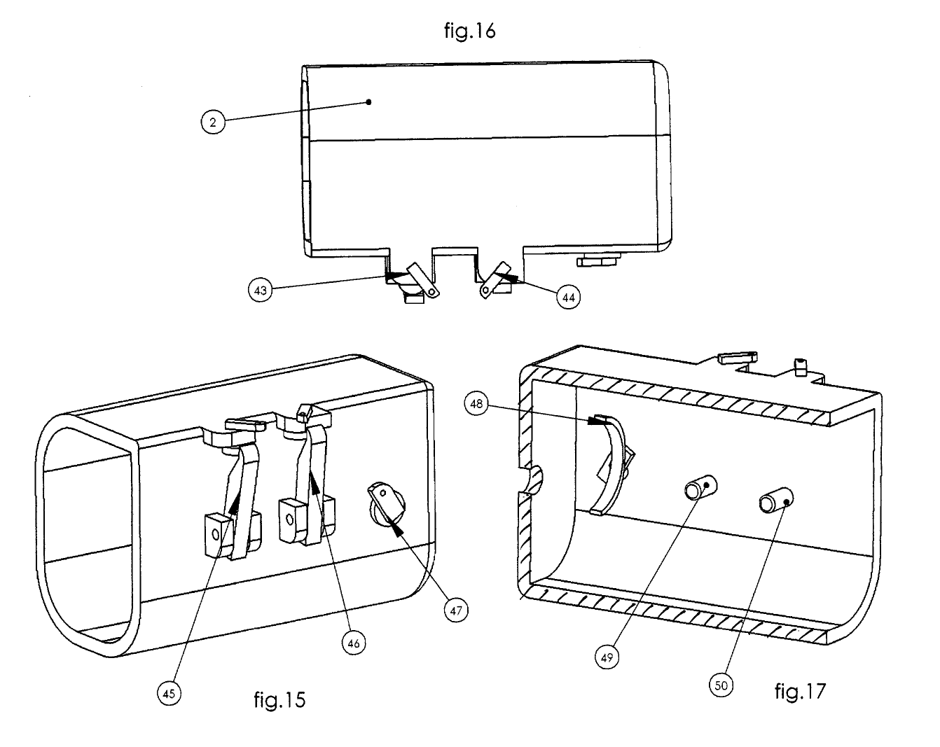

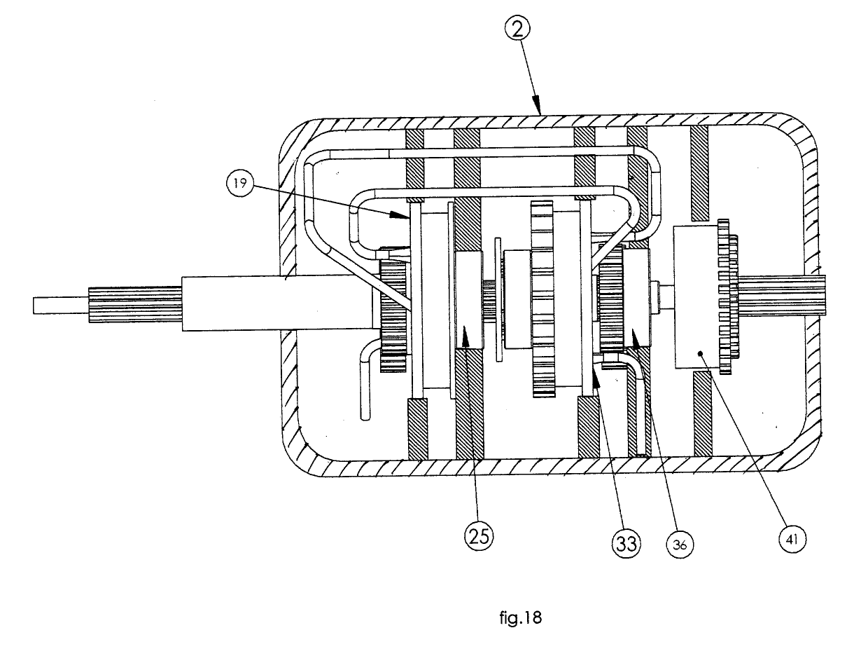

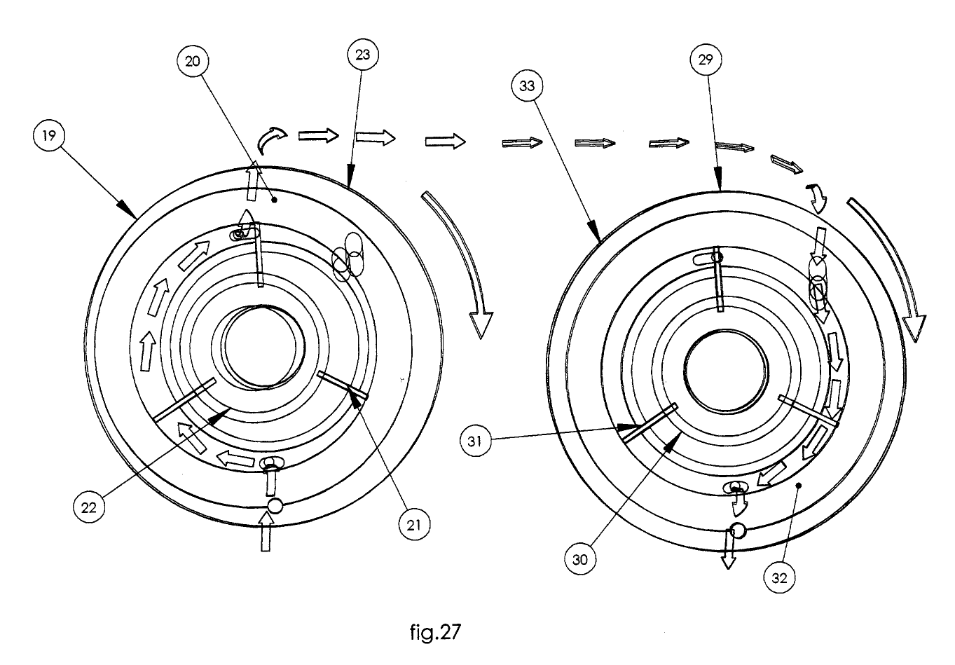

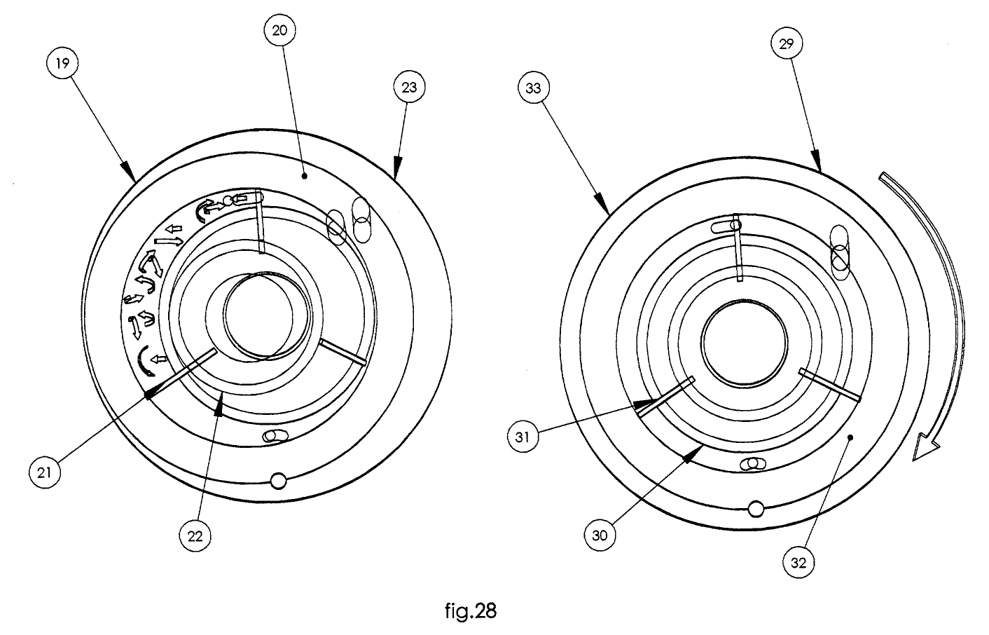

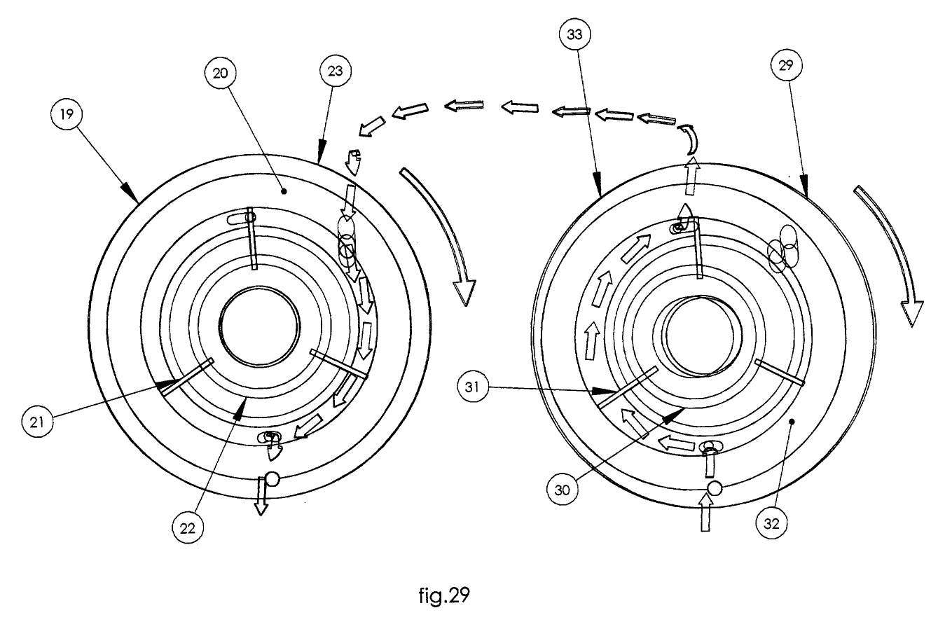

As the vehicle gets under way, gear division is desired while the engine is held at a constant rpm. FIG. 27 shows how the accelerator pump slide 20 is pushed to one side by the accelerator shift rod 50 FIG. 17 which is pushed by the accelerator shift lever 45 FIG. 15 which is pushed by the accelerator pump shift cam 43 FIG. 16. This causes oil to be drawn through pick-up tube 10, the accelerator pump cover 19 and the accelerator pump slide 20 intake ports, and pumped out of the accelerator pump cover 19 and the accelerator pump slide 20 exhaust ports. This continues through the transfer tube 9, the decelerator pump cover 33 and the decelerator pump slide 32 which are angled holes. The pressurized oil is pushed against the back of the decelerator pump vane 31 which makes the decelerator pump a turbine. The accelerator pump 4, gives a resistance force against the direction of rotation thereby splitting the torque through the input differential assembly 3. Some of the energy is recovered by using the decelerator pump 5, as a turbine thereby raising the (SDCVT) efficiency.

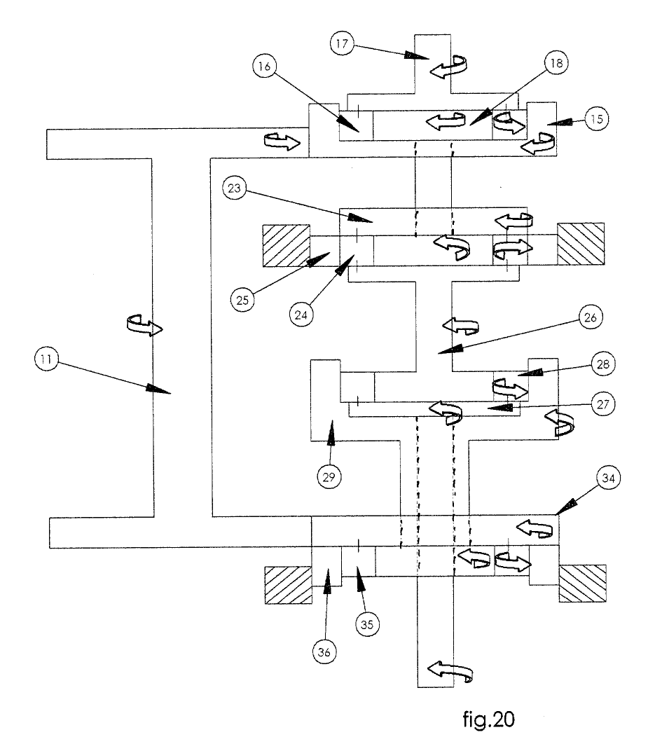

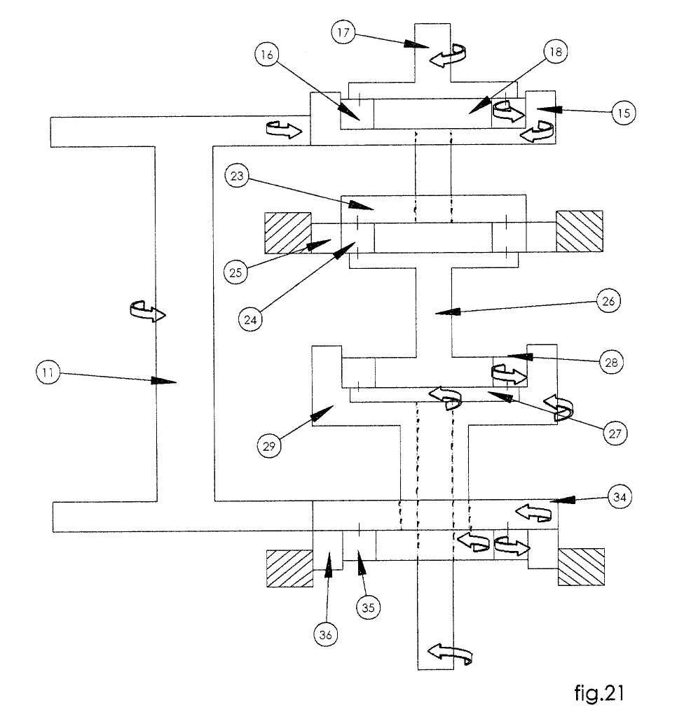

The gear rotation activity at this time can be viewed in FIG. 20 which is a mid gear realization which can not be calculated as easily as the lowest underdrive or the highest overdrive ratios but offers an infinite range between these two limits. All gears are rotating in FIG. 20 except for the underdrive internal gear 25 and the overdrive internal gear 36 which are always fixed (see FIG. 18). In addition to the rotation activity in FIG. 19, the input differential internal gear 16 is rotating opposite to the input differential internal gear 15, which is rotating opposite to the counter shaft 11, which is rotating opposite to the overdrive carrier 34, which is rotating the overdrive planet gear 35. This in turn causes the output differential internal gear with integrated decelerator pump base and overdrive sun gear 29 to rotate in the opposite direction with respect to the output differential planet gear 28.

If further gear division is desired, then the accelerator pump slide 20 is pushed all the way in by the accelerator shift rod 50 causing the accelerator pump to hydro lock because the accelerator pump slide 20 exhaust port is no longer aligned with the accelerator pump cover 19 exhaust port. This causes the (SDCVT) to be in its highest overdrive ratio, 0.31:1. Torque is no longer split through the input differential assembly 3 because the underdrive carrier and integrated accelerator pump base 23 is locked, therefore locking the input differential and underdrive sun gear 18, the underdrive base plate and integrated output differential sun gear 26, and the underdrive planet gear 24. This causes the input differential carrier 17 to drive the input differential internal gear 15 through the input differential internal gear 16 resulting in a 1.45:1 ratio. This causes the input differential internal gear 15 to drive the output differential internal gear with integrated decelerator pump base and overdrive sun gear 29 through the counter shaft 11, the overdrive carrier 34, and the overdrive planet gear 35 resulting in a 0.31:1 ratio. Finally, the output differential carrier 27 is driven by the output differential internal gear with integrated decelerator pump base and overdrive sun gear 29 through the output differential internal gear with integrated decelerator 28 which gives a 0.68:1 ratio. Therefore the final ratio is 1.45×0.31×0.68=0.31:1.

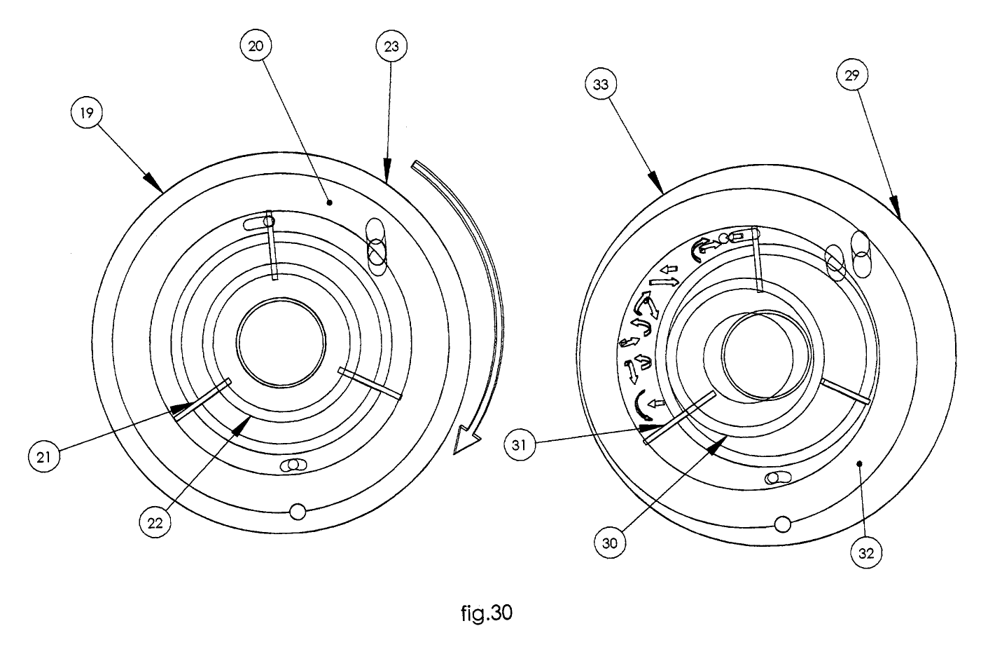

If engine braking is desired from a high road speed (down shifting), then the events as seen in FIG. 29 must take place. Here, the decelerator pump slide 32 is being pushed in by the decelerator shift rod 49 FIG. 17 which is pushed by the decelerator shift lever 46 FIG. 15 which is pushed by the decelerator shift cam 44 FIG. 16. This causes the decelerator pump 5, to start driving the accelerator pump 4 with pressurized oil in a similar manner as described in FIG. 27 except in reverse. The accelerator pump 4 is now the turbine which increases the (SDCVT) over all efficiency. Gear rotation is similar to FIG. 20. And can not be calculated easily, but offers an infinite range between 0.31:1 and 3.21:1.

FIG. 30 shows that the accelerator pump slide 20 is pushed in all the way by the decelerator shift rod 49 causing the exhaust ports in the accelerator pump slide 20 and the decelerator pump cover 33 to be blocked therefore causing the decelerator pump 5 to hydro lock resulting in a 3.21:1 ratio if the rear wheels are driving the engine.

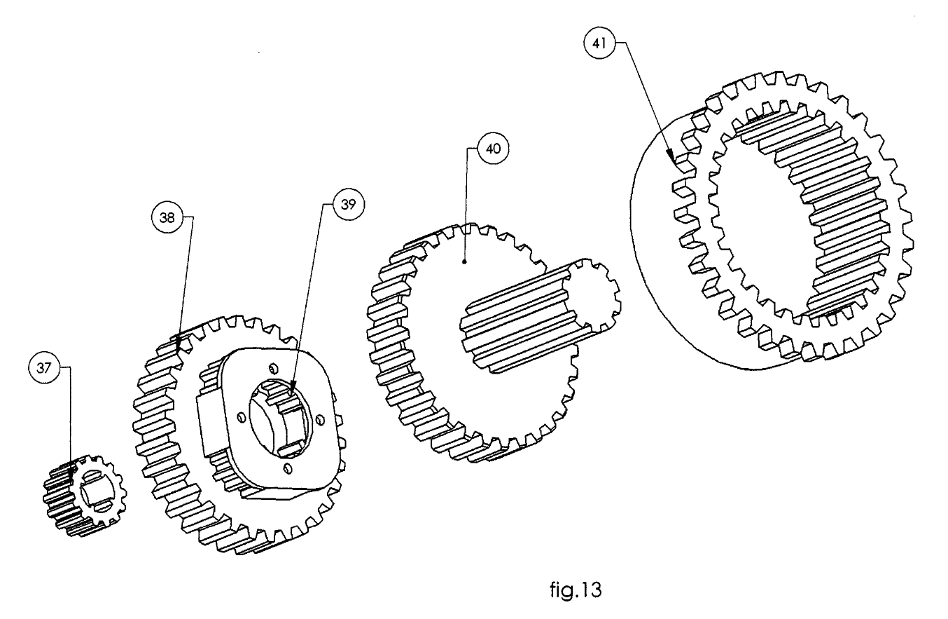

Neutral is achieved by the reverse, neutral, direct assembly (RND) 7. The (RND) sun gear 37 FIG. 13 is splined by the output differential carrier 27. In FIG. 24, the (RND) slider 41 has been pushed forward by the (RND) shift fork 48 FIG. 17 which is pushed by the (RND) shift lever 47 FIG. 15. In this position, (RND) slider 41 is not splined with the (RND) carrier 38 which does not allow any power to be transferred to the (RND) internal gear and integrated output shaft 40.

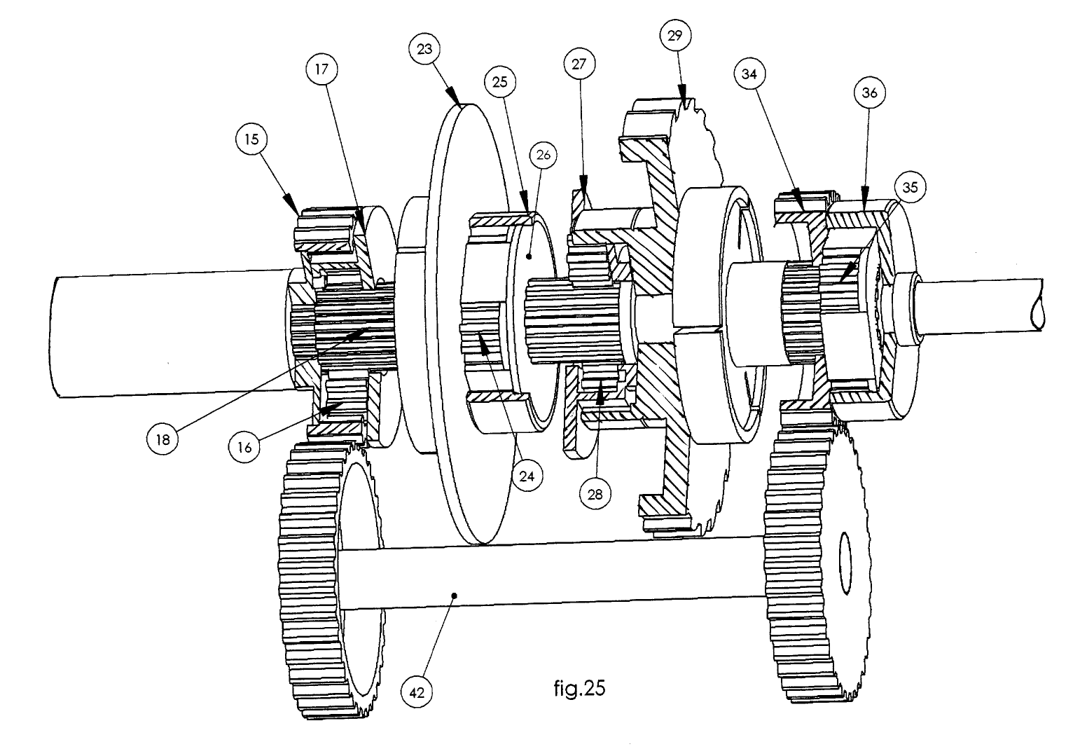

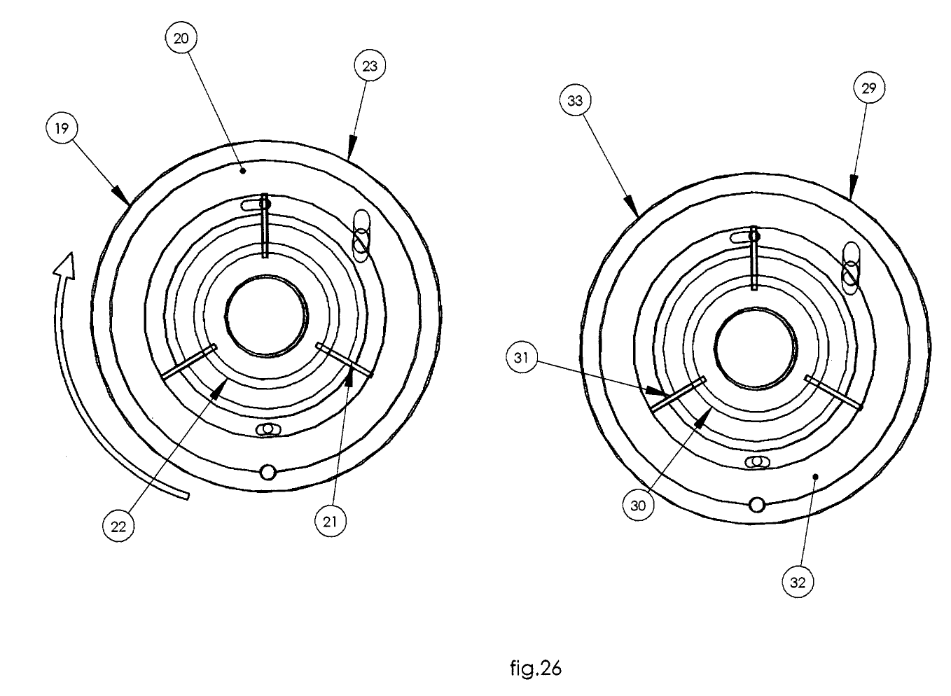

Reverse is achieved by pushing the (RND) slider 41 all the way back with the (RND) shift fork 48 so as to spline with (SDCVT) case 2 as seen in FIG. 23. This locks the (RND) carrier 38 causing the (RND) internal gear and integrated output shaft 40 to rotate in the opposite direction of the output differential carrier 27. In this embodiment it is a 1.45:1 ratio, which can be can be combined with any of the forward gear ratios (3.21:1 through 0.31:1) if desired.

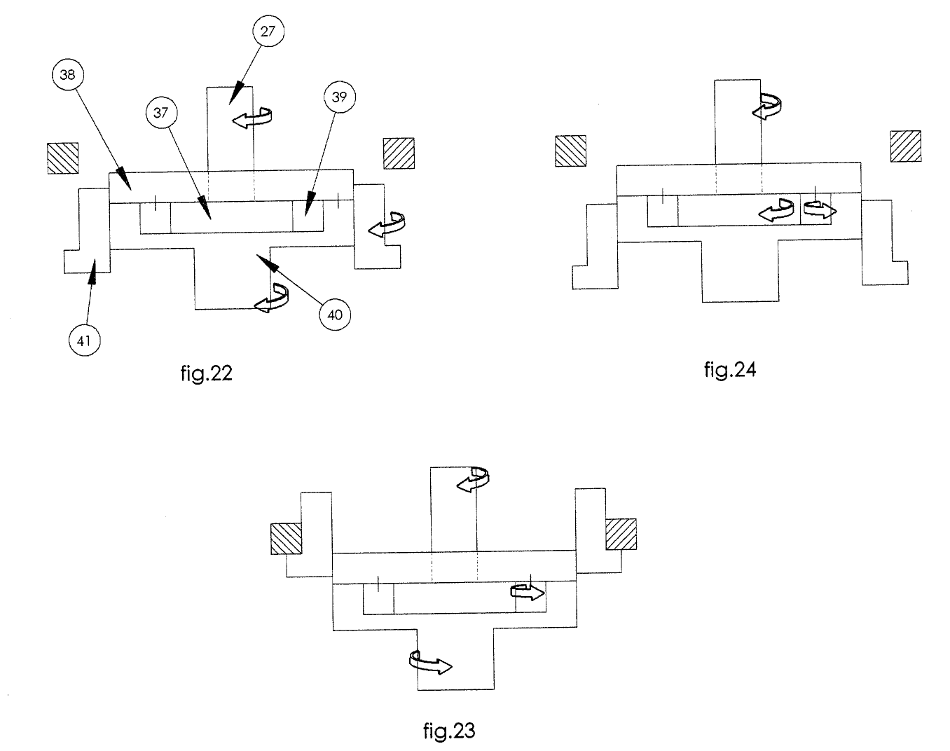

Direct is shown in FIG. 22 where the (RND) carrier 38 and the (RND) internal gear and integrated output shaft 40 are splined together by the (RND) slider 41 when pushed by the (RND) shift fork 48. In this position, the (RND) assembly 7 is locked together, therefore rotating at the same speed and direction as the output differential carrier 27. Direct in this invention only means direct across the (RND) assembly 7, not direct across the entire (SDCVT).

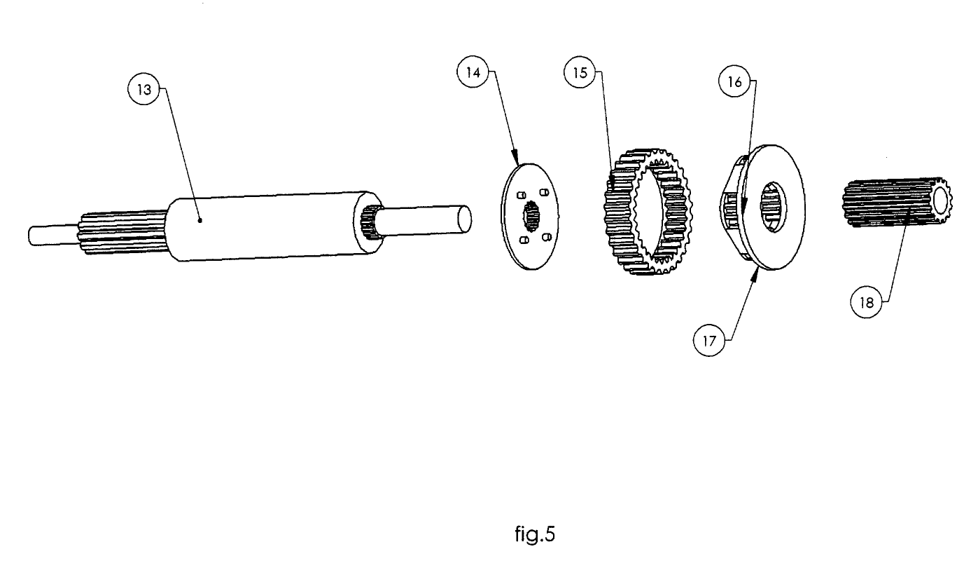

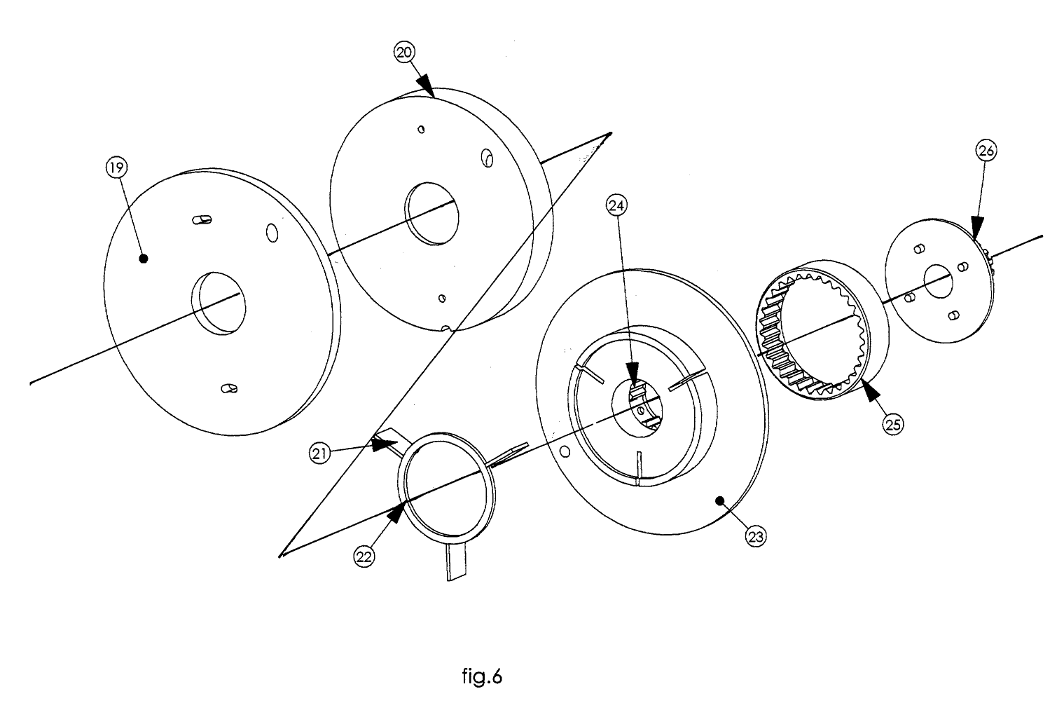

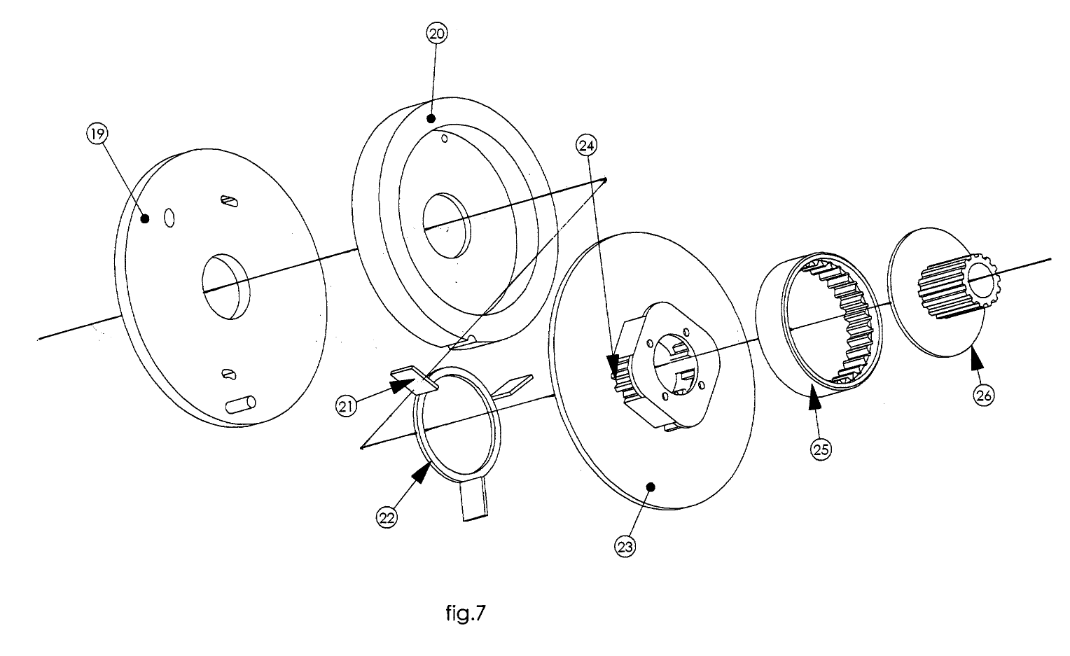

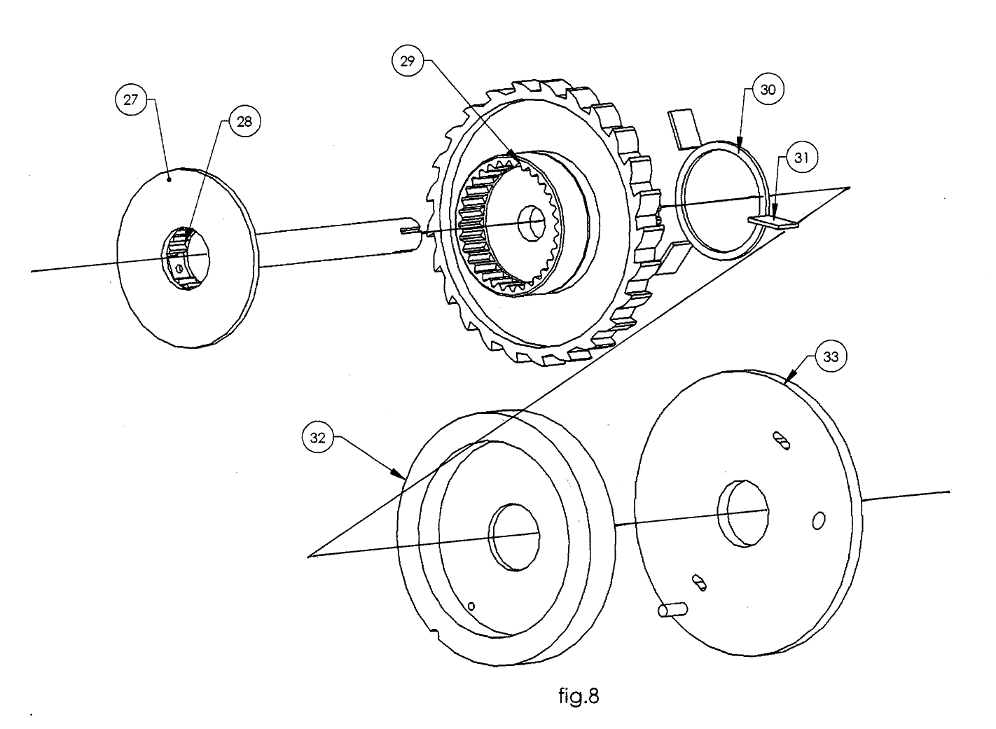

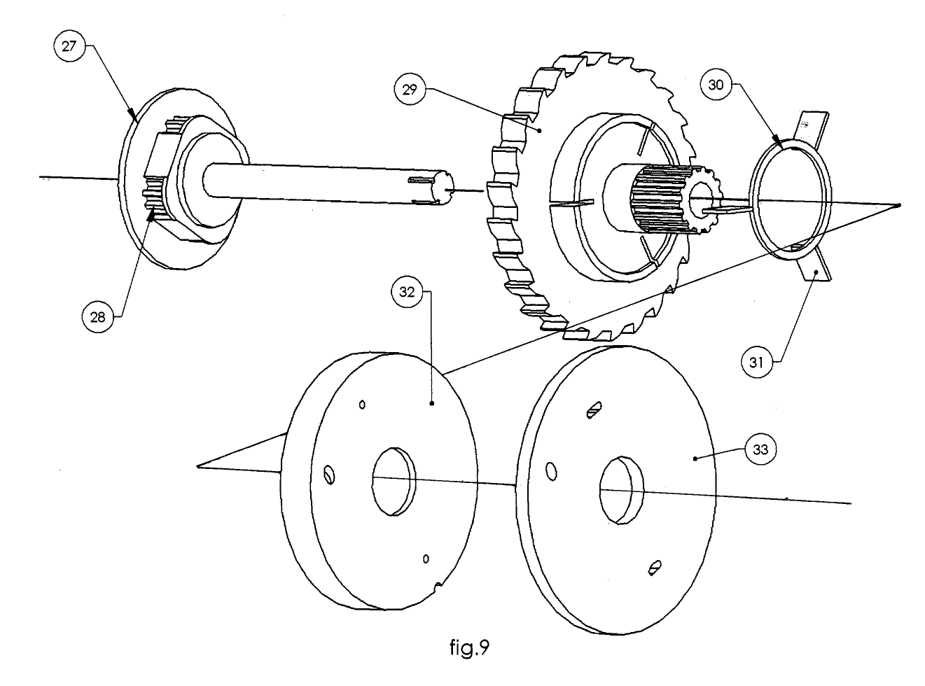

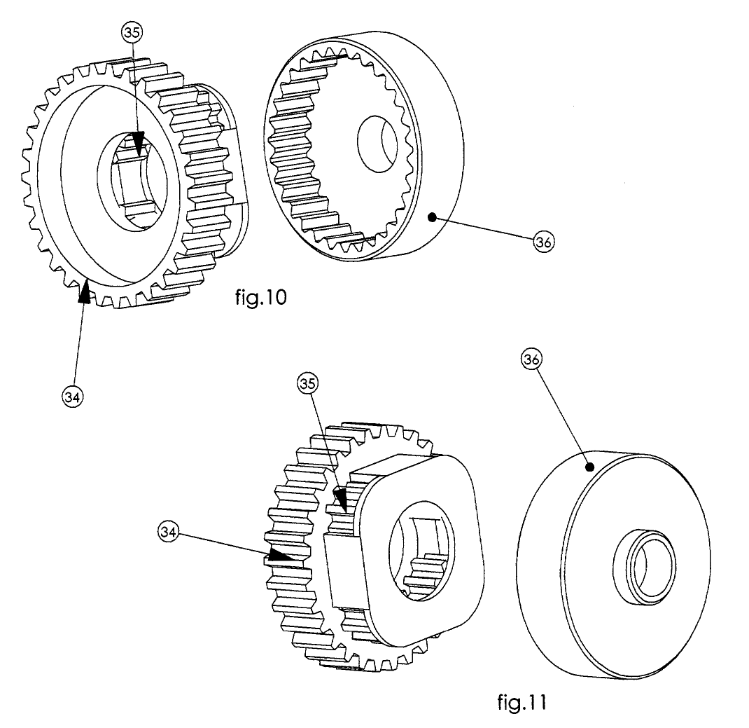

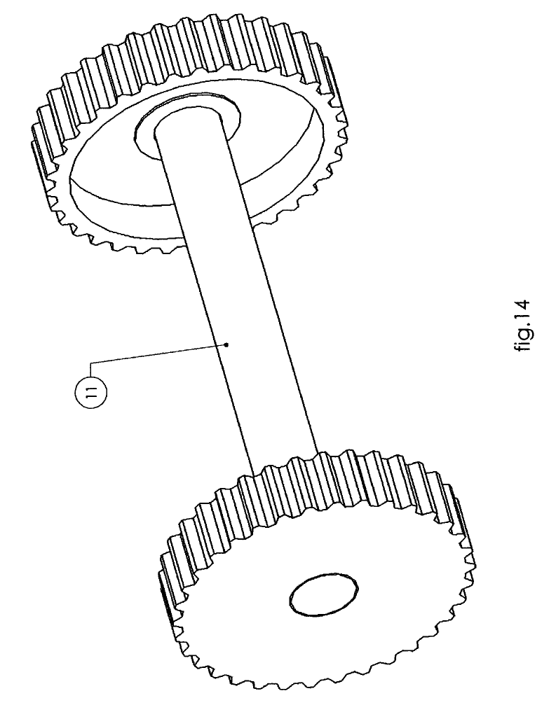

For a more detailed view of the assembly order of each of the afore mentioned assemblies and parts, examine FIG. 4 through FIG. 17.

1. What I claim as my invention is a constant variable transmission that has the efficiency of a conventional manual transmission, about 10%.

2. What I claim as my invention is constant variable transmission that is capable of delivering high amounts of torque, over 800 ft-lb.

3. What I claim as my invention is a constant variable transmission that is a direct “bolt-in” replacement, without the need for major modifications to the existing vehicle.

4. What I claim in my invention is the only constant variable transmission that uses a hybrid torque converter as means of control.

5. What I claim in my invention is a shifter linkage mechanism that is unique.

6. What I claim in my invention is a constant variable transmission that is unique in its configuration and assembly while being compact in its packaging.

7. What I claim is my invention is a variable vane pump that can be used as a turbine.
